(19) United States
(12) Patent Application Publication
(10) Pub. No.: US 2026/0194349 A1
(43) Pub. Date: Jul. 9, 2026

(54) METHOD AND SYSTEM FOR REAL-TIME RIVER WATER LEVEL MONITORING AND EARLY WARNING BASED ON DEEP LEARNING

(71) Applicant: Changjiang RiverScientificResearch Institute, Wuhan (CN)

(72) Inventors: Zhijing Li, Wuhan (CN); Qi Chen, Wuhan (CN); Guoshuai Zhang, Wuhan (CN); Xiaoxue Wang, Wuhan (CN); Wenqi Li, Wuhan (CN); Yisen Wang, Wuhan (CN); Xuhai Yang, Wuhan (CN); Zhongwu Jin, Wuhan (CN); Yinjun Zhou, Wuhan (CN); Ya Liu, Wuhan (CN); Peng Chen, Wuhan (CN); Zhaoxi Liu, Wuhan (CN); Huali Wu, Wuhan (CN); Xiaobin Liu, Wuhan (CN); Shuai Zhu, Wuhan (CN); Yujiao Liu, Wuhan (CN); Yuqin Zhang, Wuhan (CN); Qihang Zhou, Wuhan (CN); Xiuqin Ma, Wuhan (CN); Yiwu Chen, Wuhan (CN)

(21) Appl. No.: 19/346,527

(22) Filed: Sep. 30, 2025

(30) Foreign Application Priority Data
Jan. 6, 2025 (CN) 202510011804.X

(51) Int. Cl. G01C 13/00; G06T 5/60; G06T 7/13; G06T 7/246; G06T 7/40

(52) U.S. Cl. CPC G01C 13/008; G06T 5/60; G06T 7/13; G06T 7/251; G06T 7/40; G06T 2207/10016; G06T 2207/10032; G06T 2207/20021

(57) ABSTRACT

A method and system for real-time river water level monitoring and early warning based on deep learning are provided. The method includes: remote sensing images of a target watershed and real-time hydrological data from monitoring points are acquired, and a topological analysis of water flow direction is performed on the remote sensing images to construct a water flow topological network. A dynamic change feature analysis of a watershed structure is performed on the remote sensing images to generate dynamic change data, and a topological evolution fitting is performed based on the dynamic change data on the water flow topological network to obtain a dynamic topological evolution network. A multi-scale temporal trend evolution analysis is performed on the real-time hydrological data to generate temporal evolution features. An evolution feature spatial location mapping of the dynamic topological evolution network is performed to construct a three-dimensional hydrological evolution model.

### CROSS-REFERENCE TO RELATED APPLICATION

This application claims priority to Chinese Patent Application No. 202510011804.X, filed on Jan. 6, 2025, which is herein incorporated by reference in its entirety.

### TECHNICAL FIELD

The disclosure relates to the field of water level monitoring and early warning, and particularly to a method and system for real-time river water level monitoring and early warning based on deep learning.

### BACKGROUND

With the acceleration of urbanization, floods have posed a serious threat to people's lives and property. In recent years, the frequent occurrence of torrential rain and flood events has also highlighted the importance of real-time monitoring and early warning systems. Timely and accurate monitoring and early warning of river water levels are crucial for mitigating the damage caused by floods. Traditional river water level monitoring methods usually rely on manual observation and mechanical measuring devices, which often have problems with untimely and inaccurate early warning capabilities, and cannot achieve advance prevention and response. Therefore, an intelligent river water level monitoring and early warning method is needed.

### SUMMARY

To solve the above problems in the related art, the disclosure provides a method and system for real-time river water level monitoring and early warning based on deep learning.

The technical solutions of the disclosure are as follows.

The method for real-time river water level monitoring and early warning based on deep learning includes steps 1-5. In step 1, remote sensing images of a target watershed and real-time hydrological data from multiple monitoring points are acquired, and a topological analysis of water flow direction is performed on the remote sensing images of the target watershed to construct a water flow topological network. In step 2, a dynamic change feature analysis of a watershed structure is performed on the remote sensing images of the target watershed to generate dynamic change data of the watershed structure, and a topological evolution fitting is performed based on the dynamic change data of the watershed structure on the water flow topological network to obtain a dynamic topological evolution network. In step 3, a multi-scale temporal trend evolution analysis is performed on the real-time hydrological data from the multiple monitoring points to generate temporal evolution features of water flow. In step 4: an evolution feature spatial location mapping of the dynamic topological evolution network is performed based on the temporal evolution features of water flow to construct a three-dimensional hydrological evolution model, and hydrological dynamics simulation data of the target watershed is generated based on the three-dimensional hydrological evolution model. In step 5, a water level trend prediction is performed on the hydrological dynamics simulation data of the target watershed to generate predicted water level trend values, and a smoothing fitting is performed on the predicted water level trend values to construct a water level trend prediction curve. In step 6, a dynamic water level risk analysis is performed based on preset water level risk assessment criteria on the water level trend prediction curve to generate a water level risk decision-making strategy and perform real-time dynamic water level early warning operations.

The disclosure performs the topological analysis of water flow direction on the remote sensing images of the target watershed. Based on the terrain and water distribution in the remote sensing images, it determines the direction and pathways of the water flow and constructs the water flow topological network. The water flow topological network represents the water distribution as a topological structure, providing a visual representation of the water flow paths and their interrelationships. It also conducts the dynamic change feature analysis of the watershed structure on the remote sensing images of the target watershed, analyzing the impact of changes in terrain, land use, and other factors within the target watershed on the water flow. The dynamic change data of the watershed structure provides a quantitative description of the changes in the watershed structure. Based on this data, it performs a topological evolution fitting on the water flow topological network, simulating the dynamic changes of water flow within the target watershed and reflecting the spatiotemporal distribution of the water flow. The disclosure performs the multi-scale temporal trend evolution analysis on the real-time hydrological data from the multiple monitoring points, analyzing the trends in the real-time hydrological data, including long-term trends and short-term fluctuations, and generating temporal evolution features of the water flow. It extracts key features of the hydrological data, such as the magnitude of change and periodicity, providing input parameters for subsequent hydrological dynamics simulation. Based on the temporal evolution features of water flow, it maps the changes in the real-time hydrological data to an evolution of the water flow topological network, establishing the three-dimensional hydrological evolution model. It constructs a three-dimensional hydrological evolution model, integrating the real-time hydrological data, the water flow topological networks, and geographical spatial locations to provide a comprehensive understanding of the evolution of the hydrological system. Based on the three-dimensional hydrological evolution model, it generates hydrological dynamics simulation data of the target watershed, simulating the spatiotemporal distribution and changes of water flow within the target watershed, which serves as the basis for water level trend prediction. It performs the water level trend prediction on the hydrological dynamics simulation data using model-based prediction methods to obtain future water level trends and provide prediction results for future water level changes. It conducts the smoothing fitting on the predicted water level trend values to smooth the prediction curve, reducing prediction errors and fluctuations, and enhancing the reliability and stability of the prediction results. Based on the preset water level risk assessment criteria, it performs the dynamic water level risk analysis on the water level trend prediction curve, assessing and classifying the water level trends according to the risk assessment standards. It generates water level risk decision-making strategies based on the risk assessment results, formulating corresponding water level warning and response strategies to take preemptive measures against flood risks. It executes the real-time dynamic water level early warning operations, timely issuing water level warning information according to the water level risk assessment results to remind relevant departments and the public to take necessary preventive and response measures, thereby reducing the losses caused by floods.

In an embodiment, the step 1 includes steps 11-15 as follows.

In step 11: the remote sensing images of the target watershed are acquired by using an unmanned aerial vehicle (UAV), and the real-time hydrological data from the multiple monitoring points are acquired based on hydrological monitoring stations. In step 12: a global brightness average calculation is performed on the remote sensing images of the target watershed to obtain an average brightness value of the remote sensing images. In step 13: brightness equalization optimization is performed on the remote sensing images of the target watershed based on the average brightness value, to obtain brightness-balanced remote sensing images. In step 14: river texture feature enhancement processing is performed on the brightness-balanced remote sensing images to obtain texture-enhanced remote sensing images. And in step 15: the topological analysis of water flow direction is performed on the texture-enhanced remote sensing images to construct the water flow topological network.

The disclosure uses the unmanned aerial vehicle for remote sensing monitoring of the Yangtze River basin to obtain high-resolution and wide-coverage remote sensing images of the target watershed, providing detailed surface information. It acquires the real-time hydrological data from the multiple monitoring points based on the hydrological monitoring stations, obtaining hydrological parameters at different locations within the targeted watershed, including water levels and flow rates, to provide real-time hydrological information. It conducts a global brightness average calculation on the remote sensing images of the target watershed to obtain the average brightness value of the remote sensing images, which is used for subsequent brightness equalization optimization. The average brightness value provides a reference for the overall brightness of the remote sensing images, which is used to adjust the brightness distribution of the image, making the image clearer. Based on the average brightness value, it performs brightness equalization optimization on the remote sensing images of the target watershed, adjusting the brightness distribution of the remote sensing images, enhancing the contrast and details of the remote sensing images, and obtaining brightness-balanced remote sensing images. This improves the visual quality of the images, making surface features clearer and more visible, which is beneficial for subsequent image analysis and water flow topological analysis. It conducts the river texture feature enhancement processing on the brightness-balanced remote sensing images to highlight the texture features of rivers, making rivers more conspicuous in the images and obtaining texture-enhanced remote sensing images. This improves the recognizability and distinguishability of rivers, which is beneficial for subsequent water flow topological analysis and water level monitoring. It performs the topological analysis of water flow direction on the texture-enhanced remote sensing images, determining the direction and the pathways of water flow based on the texture features of rivers. It constructs a water flow topological network, providing a visual representation of the water flow paths and their interrelationships, and facilitating the understanding of the distribution and the evolution of water flow. This forms the basis for real-time river water level monitoring and early warning.

In an embodiment, the step 15 includes steps as follows.

Edge contour recognition of water flow paths is performed on the texture-enhanced remote sensing images to extract edge contour lines of water flow paths in the target watershed. A full-watershed water flow path analysis is performed on the target watershed based on the edge contour lines of water flow paths to obtain multiple water flow paths. A fine granularity of grid cells is defined on the texture-enhanced remote sensing images. A regional gridding process is performed on the texture-enhanced remote sensing images based on the fine granularity of the grid cells to obtain a regional grid of the target watershed. A grid cell connectivity analysis is performed on the regional grid to obtain grid cell connectivity data. A logical analysis of the water flow direction is performed on the multiple water flow paths based on the grid cell connectivity data to generate direction logical data of the multiple water flow paths. A spatial topological distribution analysis is performed on the multiple water flow paths to obtain spatial topological distribution data of the multiple water flow paths. And a global path topological connectivity visualization is performed on the spatial topological distribution data of the multiple water flow paths based on the direction logical data of the multiple water flow paths to construct the water flow topological network.

The disclosure performs the edge contour recognition of water flow paths on texture-enhanced remote sensing images to extract the contour lines of water flow path edges. This process separates the water flow paths from the images and accurately delineates the shape and boundaries of the water flow. The extracted contour lines of water flow path edges provide precise data for subsequent water flow path analysis. Based on the contour lines of water flow path edges, it conducts a full-watershed water flow path analysis to identify multiple water flow paths and determine the distribution and pathways of water flow throughout the entire watershed. The identification of multiple water flow paths provides a specific understanding of the direction of water flow, offering more comprehensive basic data for water level monitoring and early warning. Based on the texture-enhanced remote sensing images, it defines fine granularity of the grid cells, dividing the images into smaller grid units. This increases the precision and accuracy of image analysis. The fine granularity division of grid cells better captures the detailed information in the images, which is of great importance for the identification and analysis of water flow paths. Based on the fine granularity of the grid cells, it performs regional gridding processing on the texture-enhanced remote sensing images, transforming the images into a regional grid. This facilitates subsequent analysis and processing. The regional grid provides a structured representation of the images, making it easier to connect and analyze water flow paths. It conducts grid cell connectivity analysis on the regional grid to determine the connectivity between grid cells and establish a topological structure between them. The grid cell connectivity data provides spatial relationship information between grid cells, which serves as the basis for the logical analysis of water flow direction. Based on the grid cell connectivity data, it performs logical analysis of the water flow direction on the multiple water flow paths to determine the direction of water flow in each grid cell and establish the logical direction of water flow paths. The direction logical data of the multiple water flow paths provides information on the direction of water flow throughout the targeted watershed, offering important references for water level monitoring and early warning. It conducts the spatial topological distribution analysis on the multiple water flow paths to understand the relationships and distribution characteristics between them and reveal an overall structure of the water flow network. The spatial topological distribution data of water flow paths provides spatial correlation information between water flow paths and analyzes the convergence and dispersion of water flow. Based on the direction logical data of the multiple water flow paths, it performs the global path topological connectivity visualization on the spatial topological distribution data of the multiple water flow paths, visually presenting the relationships between the multiple water flow paths and forming the water flow topological network. The water flow topological network provides a comprehensive representation of the connections and directions of the multiple water flow paths, offering an intuitive visualization tool for real-time river water level monitoring and early warning.

In an embodiment, the step 2 includes steps 21-24 as follows.

In step 21: a multi-temporal time series analysis is performed on the remote sensing images of the target watershed to obtain a remote sensing image time series sequence. in step 22: the dynamic change feature analysis of the watershed structure is performed on the remote sensing image time series sequence to generate the dynamic change data of the watershed structure. In step 23: deep dynamic representation learning is performed on the dynamic change data of the watershed structure to obtain a dynamic evolution law of the watershed structure. And in step 24: the topological evolution fitting of the water flow topological network is performed based on the dynamic evolution law of the watershed structure to obtain the dynamic topological evolution network.

The disclosure performs the multi-temporal time series analysis on the remote sensing images of the target watershed to obtain the remote sensing image time series sequence, namely data of the remote sensing images at different time points. The remote sensing image time series sequence provides dynamic change information of the watershed, which is used for analyzing and monitoring the evolution process of the targeted watershed. It conducts the dynamic change feature analysis of the watershed structure on the remote sensing image time series sequence to detect structural changes within the targeted watershed, such as the expansion, contraction of river channels, and changes in confluence areas. The generated dynamic change data of the watershed structure provides a quantitative description of the internal structural evolution of the targeted watershed, which serves as the basis for subsequent analysis and modeling. It performs the deep dynamic representation learning on the dynamic change data of the watershed structure to learn the dynamic evolution laws of the watershed structure from the data. Deep dynamic representation learning extracts the potential features of the watershed structure evolution, revealing the structural relationships and change trends between different moments. Based on the dynamic evolution laws of the watershed structure, it conducts topological evolution fitting of the water flow topological network, integrating the dynamic changes of the watershed structure with the water flow topological network to infer the topological evolution of the water flow network. The resulting dynamic topological evolution network provides a simulation result of the changes in the water flow topological structure over time, enabling prediction and display of the trends in water flow path changes and variations in topological relationships.

In an embodiment, the step 3 includes steps 31-34 as follows.

In step 31: anomaly and missing value detection is performed on the real-time hydrological data from the multiple monitoring points to obtain hydrological missing values. In step 32: interpolation filling is performed on the real-time hydrological data from the multiple monitoring points based on the hydrological missing values to obtain optimized real-time hydrological data. In step 33: a stage flow calculation is performed on the optimized real-time hydrological data to obtain stage flow parameters of the multiple monitoring points. And in step 34: the multi-scale temporal trend evolution analysis is performed on the stage flow parameters of the multiple monitoring points to generate the temporal evolution features of water flow.

The disclosure performs the anomaly and missing value detection on real-time hydrological data from the multiple monitoring points to identify anomalies and missing values in the real-time hydrological. The hydrological missing values obtained provide information about data quality, helping to assess the reliability and completeness of the real-time hydrological. Based on these hydrological missing values, it conducts interpolation to fill in the missing values in the real-time hydrological data from multiple monitoring points, generating complete and optimized real-time hydrological data. The optimized real-time hydrological data offer more accurate and continuous hydrological observation data, providing a reliable basis for subsequent analysis and model establishment. It conducts the stage flow calculation on the optimized real-time hydrological data, computing stage flow parameters corresponding to water level data, such as average flow rate and maximum flow rate. The stage flow parameters from the multiple monitoring points provide a quantitative description of water flow, reflecting the changes in water flow and the distribution of water volume within the targeted watershed. It performs the multi-scale temporal trend evolution analysis on the stage flow parameters from the multiple monitoring points to reveal the evolution patterns of water flow on different time scales. The generated temporal evolution features of water flow include information on the trends and periodic changes in water flow, providing a basis for understanding the patterns and trends of water level changes.

In an embodiment, the step 34 specifically includes steps as follows.

Multi-temporal frequency decomposition is performed on the stage flow parameters of the multiple monitoring points to obtain a multi-scale power spectrum of water flow. Periodic fluctuation feature extraction is performed on the multi-scale power spectrum of the water flow to obtain periodic fluctuation features. Non-stationary variable identification is performed on the periodic fluctuation features to obtain non-stationary variable values of the multi-scale power spectrum. Trend turning point marking is performed on the multi-scale power spectrum of the water flow based on the non-stationary variable values of the multi-scale power spectrum to obtain trend turning points. And the multi-scale temporal trend evolution analysis is performed on the trend turning points to generate the temporal evolution features of water flow.

The disclosure performs the multi-temporal frequency decomposition on the stage flow parameters from the multiple monitoring points, breaking down the water flow data into components of different scales to obtain the multi-scale power spectrum of water flow. The multi-scale power spectrum of water flow provides information on the energy distribution across different frequencies and time scales, revealing the periodic fluctuation characteristics of water flow. It performs the periodic fluctuation feature extraction on the multi-scale power spectrum of water flow to identify periodic components and fluctuation features within the multi-scale power spectrum. The extracted periodic fluctuation features include information such as peaks, troughs, and fluctuation amplitudes, which are used to describe the periodic changes and fluctuation conditions of water flow. It performs the non-stationary variable identification on the periodic fluctuation features to detect non-stationary variable values in the multi-scale power spectrum. These non-stationary variable values provide information on the non-stationarity of water flow fluctuations, aiding in the understanding and analysis of the characteristics of water flow changes. Based on the non-stationary variable values of the multi-scale power spectrum, it performs the trend turning point marking on the multi-scale power spectrum of water flow to identify the points where trends change. These trend turning points reveal the inflection points in the trends of water flow changes and mark significant fluctuation turning positions. It performs temporal trend evolution analysis on the trend turning points to analyze the trend changes and evolution patterns in the time series data of water flow. The generated temporal evolution features of water flow can include information such as trend increases, decreases, and periodic changes, providing a temporal feature description of water flow variations.

In an embodiment, the step 4 specifically includes steps 41-44 as follows.

In step 41: spatial correlation analysis is performed on the real-time hydrological data from the multiple monitoring points to generate spatial correlation data of the multiple monitoring points. In step 42: spatial registration is performed on the temporal evolution features of water flow based on the spatial correlation data of the multiple monitoring points to obtain spatial locations of the temporal evolution features. In step 43: the temporal evolution features of water flow are mapped to the dynamic topological evolution network based on the spatial locations of the temporal evolution features, and dynamic rendering modeling is performed to construct the three-dimensional hydrological evolution model. And in step 44: a hydrological dynamics simulation calculation of a future time period is performed on the three-dimensional hydrological evolution model to generate the hydrological dynamics simulation data of the target watershed.

The disclosure performs the spatial correlation analysis of real-time hydrological data from the multiple monitoring points to analyze the spatial relationships between multiple monitoring points. The generated spatial correlation data of the multiple monitoring points provides information on the relative positions and the degree of spatial correlation between the multiple monitoring points, facilitating the understanding of the mutual influences and spatial variation characteristics between the multiple monitoring points. Based on the spatial correlation data of the multiple monitoring points, it conducts spatial registration of the temporal evolution features of water flow, aligning the evolution features from the multiple monitoring points to their corresponding spatial locations. The spatial locations of the evolution features provide spatial positioning of the temporal evolution features of water flow, enabling intuitive comparison and analysis of the evolution features from the multiple monitoring points. It maps the temporal evolution features of water flow to the dynamic topological evolution network based on the spatial locations of the evolution features. Dynamic rendering modeling is performed to map the evolution features to the three-dimensional hydrological evolution model, which visually presents the spatial distribution and topological changes of hydrological evolution, providing an intuitive visualization effect. It performs the hydrological dynamics simulation calculation of a future time period on the three-dimensional hydrological evolution model to simulate future hydrological changes. The generated hydrological dynamics simulation data of the targeted watershed provides predicted results for hydrological elements such as water levels and flow rates in the future time period, offering an estimation of future hydrological conditions for the real-time river water level monitoring and early warning system.

In an embodiment, the step 5 specifically includes steps 51-55 as follows.

In step 51: water level distribution analysis is performed on the hydrological dynamics simulation data of the target watershed at different time points to obtain water level distribution data at the different time points. In step 52: the water level trend prediction is performed on the water level distribution data at the different time points to generate the predicted water level trend values. In step 53: hyperparameter optimization is performed on the predicted water level trend values to obtain trend prediction hyperparameters. In step 54: iterative sliding time series prediction is performed based on the trend prediction hyperparameters to obtain a water level trend prediction sequence. In step 55: the smoothing fitting is performed on the water level trend prediction sequence to construct the water level trend prediction curve.

The disclosure performs the water level distribution analysis on the hydrological dynamics simulation data of the targeted watershed at different time points to understand the water level distribution at various moments. The generated water level distribution data at the different time points provide water level information at different moments and enables the analysis of the spatiotemporal variation characteristics of water levels. It performs the water level trend prediction on the water level distribution data at the multiple time points to forecast the changes in water levels over a future period. The generated predicted water level trend values provide forecast results for future water levels, offering trend information on water level changes for the real-time river water level monitoring and early warning system. It performs the hyperparameter optimization on the predicted water level trend values to adjust the parameters of the prediction model, enhancing the accuracy and stability of the predictions. The trend prediction hyperparameters obtained through hyperparameter optimization improve the performance of the water level trend prediction model, making the prediction results more reliable and precise. Based on the trend prediction hyperparameters, it performs iterative sliding time series prediction according to historical data to obtain water level trend prediction sequence. The generated water level trend prediction sequence provides detailed forecast results for water level changes over a future period, offering more specific water level trend information for the real-time river water level monitoring and early warning system. It performs the smoothing fitting on the water level trend prediction sequence to smooth the prediction results, eliminating noise and instability in the predictions. The constructed water level trend prediction curve provides a smooth trend of water level changes, more intuitively displaying the trends and fluctuation characteristics of water level variations.

In an embodiment, the step 6 specifically includes steps 61-65 as follows.

Step 61: water level change rate calculation is performed on the water level trend prediction curve to obtain a water level trend change rate. Step 62: quantitative analysis of water level peaks is performed based on the water level trend change rate to obtain water level peak trend data. Step 63: the dynamic water level risk analysis is performed on the water level peak trend data based on the preset water level risk assessment criteria to obtain water level risk assessment data. Step 64: risk decision analysis is performed on the water level risk assessment data to generate the water level risk decision-making strategy. And step 65: the real-time dynamic water level early warning operations are executed based on the water level risk decision-making strategies.

The disclosure performs the water level change rate calculation on the water level trend prediction curve to quantify the rate of water level changes. The generated water level trend change rate provides information on the rate of water level changes, assessing the speed of water level variations. Based on the water level trend change rate, it conducts quantitative analysis of water level peaks to identify peak characteristics of water levels. The generated water level peak trend data provides forecast results for water level peaks, offering insights into the peak periods and high water level change trends. It performs the dynamic water level risk analysis on the water level peak trend data based on the preset water level risk assessment criteria to evaluate the risk level of water levels. The generated water level risk assessment data provides the assessment results of water level risks, determining whether the water level has reached the preset risk threshold. It performs the risk decision analysis on the water level risk assessment data to formulate decision-making strategy for different water level risk scenarios. The generated water level risk decision-making strategy provide recommendations for different water level risk levels, enabling the implementation of corresponding early warning and emergency measures. Based on the water level risk decision-making strategy, it executes the real-time dynamic water level early warning operations, and issues a water level early warning signal in a timely manner according to the preset decision-making strategy. The implemented real-time dynamic water level early warning operations offer decision support and early warning prompts, helping to reduce the risk of floods. For example, the method is implemented by a processor, and the water level early warning signal includes a water level early warning message, which is sent by the processor to mobile phones of personnel around the target watershed via the Internet. After the mobile phones receive the water level early warning message, the mobile phone vibrates to alert the personnels of flood risks.

In an embodiment, a system for the real-time river water level monitoring and the early warning based on the deep learning is provided, which includes a flow topology module, a situation evolution module, a temporal trend evolution module, a hydrological evolution model module, a water level trend prediction module, and a water level risk early warning module. The flow topology module is configured to acquire remote sensing images of a target watershed and real-time hydrological data from multiple monitoring points, and perform a topological analysis of water flow direction on the remote sensing images of the target watershed to construct a water flow topological network. The situation evolution module is configured to perform a dynamic change feature analysis of a watershed structure on the remote sensing images of the target watershed to generate dynamic change data of the watershed structure, and perform, based on the dynamic change data of the watershed structure, a topological evolution fitting on the water flow topological network to obtain a dynamic topological evolution network. The temporal trend evolution module is configured to perform a multi-scale temporal trend evolution analysis on the real-time hydrological data from the multiple monitoring points to generate temporal evolution features of water flow. The hydrological evolution model module is configured to perform, based on the temporal evolution features of water flow, an evolution feature spatial location mapping of the dynamic topological evolution network to construct a three-dimensional hydrological evolution model, and generate hydrological dynamics simulation data of the target watershed based on the three-dimensional hydrological evolution model. The water level trend prediction module is configured to perform a water level trend prediction on the hydrological dynamics simulation data of the target watershed to generate predicted water level trend values, and perform a smoothing fitting on the predicted water level trend values to construct a water level trend prediction curve. And the water level risk early warning module is configured to perform, based on preset water level risk assessment criteria, a dynamic water level risk analysis on the water level trend prediction curve to generate a water level risk decision-making strategy configured to perform real-time dynamic water level early warning operations.

In an embodiment, each of the flow topology module, the situation evolution module, the temporal trend evolution module, the hydrological evolution model module, the water level trend prediction module, and the water level risk early warning module is embodied by at least one processor and at least one memory coupled to the at least one processor, and the at least one memory stores computer programs executable by the at least one processor.

The system of the disclosure acquires the remote sensing images of the target watershed and the real-time hydrological data from the multiple monitoring points, providing spatial information of the target watershed and hydrological data. The system performs the topological analysis of water flow direction to reveal the pathways and directional relationships of water flow within the targeted watershed. The constructed water flow topological network forms the topological structure of water flow within the targeted watershed, providing a basis for subsequent hydrological analysis. The system performs the dynamic change feature analysis of the watershed structure on the remote sensing images of the target watershed to understand the changes in the topography, the land use, and other factors within the targeted watershed. The generated dynamic change data of the watershed structure provides information on the evolution of the watershed structure, allowing for the analysis of trends and characteristics within the targeted watershed. The system performs the topological evolution fitting of the water flow topological network, integrating the changes in watershed structure with the topological relationships of water flow. The resulting dynamic topological evolution network provides a simulation result of how the water flow topology changes over time, facilitating an understanding of the dynamic changes in water flow paths within the targeted watershed. The system performs the multi-scale temporal trend evolution analysis on the real-time hydrological data from the multiple monitoring points to reveal the patterns of change in water flow rates. The generated temporal evolution features of water flow provide information on the temporal evolution of hydrological data, enabling an understanding of the trends and periodic changes in water flow rates. Based on the temporal evolution features of water flow, the system maps the evolution features to the dynamic topological evolution network, integrating the hydrological data with the topological network. The constructed three-dimensional hydrological evolution model provides a simulation result of the hydrological processes within the targeted watershed, allowing for a comprehensive analysis of the changes and interactions of hydrological elements. The system performs the water level trend prediction on the hydrological dynamics simulation data of the targeted watershed to gain advance knowledge of the trends and peaks in water level changes. The generated predicted water level trend values provide forecast results for water levels over a future period, enabling the formulation of corresponding early warning strategies and response measures. The system performs the smoothing fitting on the predicted water level trend values to eliminate noise and abrupt changes, resulting in a smoother water level prediction curve. Based on the preset water level risk assessment criteria, the system performs the dynamic water level risk analysis on the water level trend prediction curve to assess the risk level of water levels. The generated water level risk decision-making strategies provide recommendations for different water level risk levels, enabling the formulation of water level early warning and emergency response strategies. By executing the real-time dynamic water level early warning operations, which enables the timely issuance of water level early warning signals, provides decision support and early warning prompts, and helps to reduce the risk of floods.

### BRIEF DESCRIPTION OF DRAWINGS

FIG. 1 illustrates a schematic flowchart of a method for real-time river water level monitoring and early warning based on deep learning in the disclosure.

FIG. 2 illustrates a specific schematic flowchart of step 1 in the disclosure.

FIG. 3 illustrates a specific schematic flowchart of step 2 in the disclosure.

FIG. 4 illustrates a specific schematic flowchart of step 3 in the disclosure.

### DETAILED DESCRIPTION OF EMBODIMENTS

It should be understood that the specific embodiments described herein are only for explaining the disclosure and are not intended to limit the disclosure.

In an embodiment, a method and a system for real-time river water level monitoring and early warning based on the deep learning is provided. The implementing entities of the method and the system for real-time river water level monitoring and early warning based on the deep learning include, but are not limited to, the following that are equipped with the system: mechanical equipment, data processing platforms, cloud server nodes, network upload devices, etc., all of which can be regarded as the general-purpose computing nodes of the disclosure. The data processing platform includes, but is not limited to, at least one of the following: audio and image management systems, information management systems, and cloud-based data management systems.

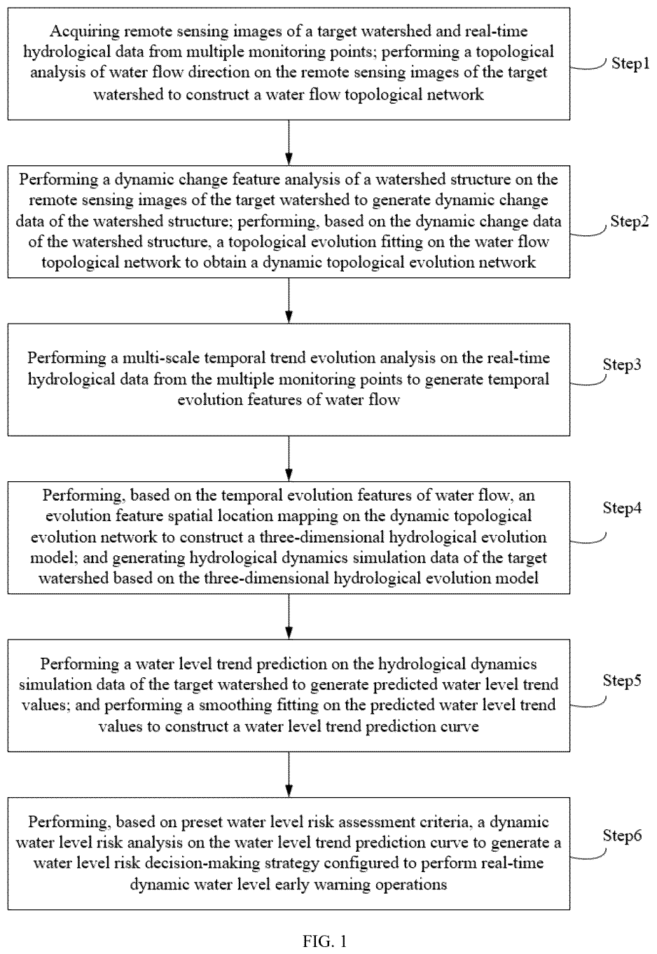

As shown in FIGS. 1-4, the disclosure provides a method for real-time river water level monitoring and early warning based on deep learning, which includes steps 1-5 as follows. In step 1: remote sensing images of a target watershed and real-time hydrological data from multiple monitoring points are acquired, and a topological analysis of water flow direction is performed on the remote sensing images of the target watershed to construct a water flow topological network. In step 2: a dynamic change feature analysis of a watershed structure is performed on the remote sensing images of the target watershed to generate dynamic change data of the watershed structure, and a topological evolution fitting is performed based on the dynamic change data of the watershed structure on the water flow topological network to obtain a dynamic topological evolution network. In step 3: a multi-scale temporal trend evolution analysis is performed on the real-time hydrological data from the multiple monitoring points to generate temporal evolution features of water flow. In step 4: an evolution feature spatial location mapping of the dynamic topological evolution network is performed based on the temporal evolution features of water flow to construct a three-dimensional hydrological evolution model, and hydrological dynamics simulation data of the target watershed is generated based on the three-dimensional hydrological evolution model. In step 5: a water level trend prediction is performed on the hydrological dynamics simulation data of the target watershed to generate predicted water level trend values, and a smoothing fitting is performed on the predicted water level trend values to construct a water level trend prediction curve. In step 6: a dynamic water level risk analysis is performed based on preset water level risk assessment criteria on the water level trend prediction curve to generate a water level risk decision-making strategy and perform real-time dynamic water level early warning operations.

The disclosure performs the topological analysis of water flow direction on the remote sensing images of the target watershed. Based on the terrain and water distribution in the remote sensing images, it determines the direction and pathways of the water flow and constructs the water flow topological network. The water flow topological network represents the water distribution as a topological structure, providing a visual representation of the water flow paths and their interrelationships. It also conducts the dynamic change feature analysis of the watershed structure on the remote sensing images of the target watershed, analyzing the impact of changes in terrain, land use, and other factors within the target watershed on the water flow. The dynamic change data of the watershed structure provides a quantitative description of the changes in the watershed structure. Based on this data, it performs a topological evolution fitting on the water flow topological network, simulating the dynamic changes of water flow within the target watershed and reflecting the spatiotemporal distribution of the water flow. The disclosure performs the multi-scale temporal trend evolution analysis on the real-time hydrological data from the multiple monitoring points, analyzing the trends in the real-time hydrological data, including long-term trends and short-term fluctuations, and generating temporal evolution features of the water flow. It extracts key features of the hydrological data, such as the magnitude of change and periodicity, providing input parameters for subsequent hydrological dynamics simulation. Based on the temporal evolution features of water flow, it maps the changes in the real-time hydrological data to an evolution of the water flow topological network, establishing the three-dimensional hydrological evolution model. It constructs a three-dimensional hydrological evolution model, integrating the real-time hydrological data, the water flow topological networks, and geographical spatial locations to provide a comprehensive understanding of the evolution of the hydrological system. Based on the three-dimensional hydrological evolution model, it generates hydrological dynamics simulation data of the target watershed, simulating the spatiotemporal distribution and changes of water flow within the target watershed, which serves as the basis for water level trend prediction. It performs the water level trend prediction on the hydrological dynamics simulation data using model-based prediction methods to obtain future water level trends and provide prediction results for future water level changes. It conducts the smoothing fitting on the predicted water level trend values to smooth the prediction curve, reducing prediction errors and fluctuations, and enhancing the reliability and stability of the prediction results. Based on the preset water level risk assessment criteria, it performs the dynamic water level risk analysis on the water level trend prediction curve, assessing and classifying the water level trends according to the risk assessment standards. It generates water level risk decision-making strategies based on the risk assessment results, formulating corresponding water level warning and response strategies to take preemptive measures against flood risks. It executes the real-time dynamic water level early warning operations, timely issuing water level warning information according to the water level risk assessment results to remind relevant departments and the public to take necessary preventive and response measures, thereby reducing the losses caused by floods.

In an embodiment, as shown in FIG. 1, which illustrates a schematic flowchart of a method for real-time river water level monitoring and early warning based on deep learning in the disclosure. The step 1 includes that remote sensing images of a target watershed and real-time hydrological data from multiple monitoring points are acquired, and a topological analysis of water flow direction is performed on the remote sensing images of the target watershed to construct a water flow topological network.

In the embodiment, high-resolution remote sensing image data of the river basin segment to be analyzed in the Yangtze River basin are collected, such as satellite images and UAV images. At the same time, the real-time hydrological observation data (i.e., the real-time hydrological data from multiple monitoring points) such as water levels and flow rates from the multiple hydrological monitoring stations within the Yangtze River basin are obtained. The remote sensing images are subjected to precise water body segmentation and extraction, and the extracted water body areas are divided into a series of regular grids. Each grid cell represents a flow unit. Combined with terrain data such as digital elevation models (DEMs), the flow direction of each grid cell is calculated. Based on the elevation differences between adjacent grid cells, the direction and flow rate of water are determined. All grid cells and their flow relationships are constructed into a complete water flow topological network. In the water flow topological network, the nodes represent grid cells, and the edges represent flow relationships. According to the results of the topological analysis of water flow direction, the water flow topological network is constructed. The water flow topological network is a network structure composed of water flow paths and connection relationships, reflecting the flow of water within the target watershed.

The step 2 includes that a dynamic change feature analysis of a watershed structure is performed on the remote sensing images of the target watershed to generate dynamic change data of the watershed structure, and a topological evolution fitting is performed based on the dynamic change data of the watershed structure on the water flow topological network to obtain a dynamic topological evolution network.

In the embodiment, deep learning-based semantic segmentation or object detection techniques are employed to identify and extract land cover elements within the targeted watershed, such as river channels, lakes, and vegetation. By comparing the segmentation results at different time points, dynamic change features of these land cover elements are analyzed, including changes in area, location, and shape. Time series data describing the dynamic changes in the watershed structure are generated, with indicators such as river channel extension and lake area reduction. By utilizing the dynamic change data of the watershed structure, the attributes and the connectivity of each node (grid cell) in the network are updated. Based on dynamic changes such as river channel migration and lake expansion or contraction, the connectivity and the weights of the edges in the network are adjusted to simulate the evolution process of the water flow topological structure. Through time series fitting, a complete dynamic topological evolution network is generated, which describes the evolutionary trajectory of the water flow topology over the temporal scale.

The step 3 includes that a multi-scale temporal trend evolution analysis is performed on the real-time hydrological data from the multiple monitoring points to generate temporal evolution features of water flow.

In the embodiment, the real-time hydrological observation data such as water levels and flow rates from the multiple hydrological monitoring stations within the Yangtze River basin are collected. The collected raw data are preprocessed with quality checks and filling of missing values to ensure data integrity and reliability. For the hydrological data series of each monitoring station, trend analysis is conducted on different time scales (such as daily, weekly, monthly, quarterly, and annual). Various statistical analysis methods, like linear regression and the Mann-Kendall trend test, are employed to identify linear or non-linear trends in the data series and to analyze the variation trends of hydrological elements on different time scales, such as increases or decreases in water level/flow rate and seasonal fluctuations. For each monitoring station, the trend analysis results from different time scales are integrated into a temporal evolution feature vector. The feature vector contains information on the variation trends of hydrological elements across multiple time scales and can more comprehensively describe the evolution state of the hydrological time series. The temporal evolution feature vectors from all monitoring stations are aggregated to form a complete hydrological temporal evolution feature database.

The step 4 includes that an evolution feature spatial location mapping of the dynamic topological evolution network is performed based on the temporal evolution features of water flow to construct a three-dimensional hydrological evolution model, and hydrological dynamics simulation data of the target watershed is generated based on the three-dimensional hydrological evolution model.

In the embodiment, the temporal evolution feature data from hydrological monitoring stations are correlated with their corresponding geographic spatial locations (monitoring station coordinates). Using spatial interpolation or other geographic information processing methods, discrete monitoring point data are extended to grid space of the entire watershed. The dynamic topological evolution network serves as an underlying framework, and the dynamic changes in watershed structure and the temporal evolution features of water flow are mapped to the nodes and the edges of the network. Utilizing three-dimensional (3D) visualization technology, a three-dimensional model that can display the spatiotemporal evolution of hydrology within the targeted watershed is constructed. This model dynamically shows the changes in hydrological elements (such as rivers and lakes) within the targeted watershed and the spatiotemporal distribution of hydrological parameters (such as water levels and flow rates). Based on the three-dimensional hydrological evolution model, numerical simulation or machine learning methods are used to simulate the hydrological dynamics within the targeted watershed. The simulation results include changes in hydrological parameters such as water levels, flow rates, water velocity, and flow direction over space and time, generating high spatiotemporal resolution hydrological dynamics simulation data that cover the entire watershed.

The step 5 includes that a water level trend prediction is performed on the hydrological dynamics simulation data of the target watershed to generate predicted water level trend values, and a smoothing fitting is performed on the predicted water level trend values to construct a water level trend prediction curve.

In the embodiment, based on the hydrological dynamics simulation data of the targeted watershed, the water level time series data of each monitoring point are extracted. Time series analysis is conducted on these water level time series data to identify the trend components within them. Time series prediction methods such as linear regression, autoregressive integrated moving average (ARIM), and exponential smoothing are employed to predict the water level trends and generate predicted water level trend values of a future period. The predicted water level trend values are then smoothed to remove noise components. The smoothing fitting methods commonly include moving average smoothing, cubic spline smoothing, and locally weighted regression smoothing. Through the smoothing fitting, a smooth water level trend prediction curve is constructed.

The step 6 includes that a dynamic water level risk analysis is performed based on preset water level risk assessment criteria on the water level trend prediction curve to generate a water level risk decision-making strategy configured to perform real-time dynamic water level early warning operations.

In the embodiment, the preset water level risk assessment criteria suitable for the targeted watershed are established based on the geographical characteristics of the targeted watershed, historical hydrological data, and flood control standards. These criteria include thresholds such as water level warning lines, flood warning lines, and alert water levels, which are reasonably set to ensure timely and effective identification and response to different levels of water level risks. The water level trend prediction curve is compared and analyzed with the preset water level risk assessment criteria to identify intersection points between the prediction curve and the risk thresholds, determine the water level risk levels that may occur in the future period, and promptly detect potential water level over-alert risks, thereby allowing sufficient reaction time for subsequent emergency plans. Based on the results of the dynamic risk analysis, corresponding emergency response strategies are formulated, which include specific measures such as early warning issuance, emergency material preparation, and evacuation under different risk levels to ensure timely and effective actions in the face of varying degrees of water level risks. The formulated water level risk decision-making strategies are converted into operable early warning issuance and emergency response procedures, and a linkage mechanism is established among information monitoring, early warning issuance, and emergency response. The changes in the water level trend prediction curve are monitored in real time, and the corresponding emergency plans are activated immediately once the warning criteria are met.

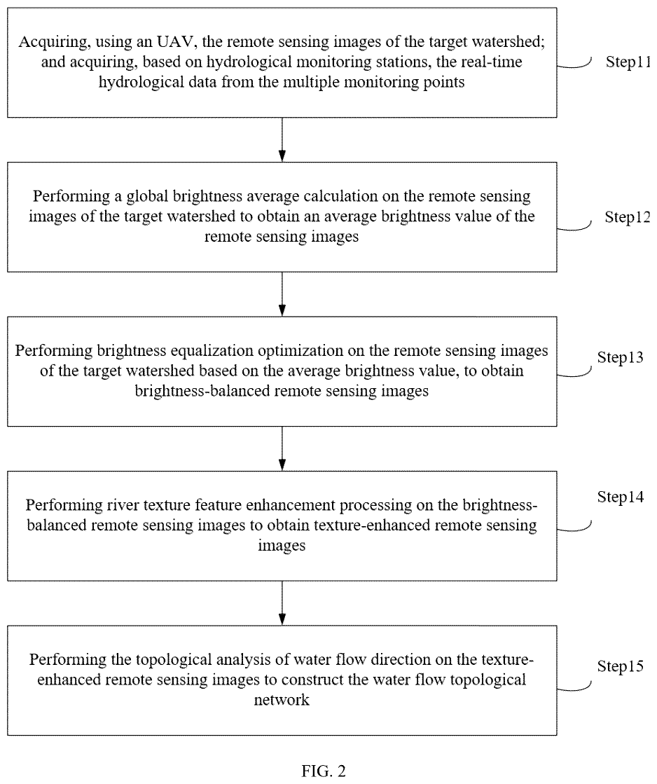

In an embodiment, as shown in FIG. 2, which illustrates a specific schematic flowchart of step 1 in the disclosure, and the step 1 includes steps 11-15 as follows. In step 11: the remote sensing images of the target watershed are acquired by using an UAV, and the real-time hydrological data from the multiple monitoring points are acquired based on hydrological monitoring stations. In step 12: a global brightness average calculation is performed on the remote sensing images of the target watershed to obtain an average brightness value of the remote sensing images. In step 13: brightness equalization optimization is performed on the remote sensing images of the target watershed based on the average brightness value, to obtain brightness-balanced remote sensing images. In step 14: river texture feature enhancement processing is performed on the brightness-balanced remote sensing images to obtain texture-enhanced remote sensing images. And in step 15: the topological analysis of water flow direction is performed on the texture-enhanced remote sensing images to construct the water flow topological network.

In the embodiment, an UAV platform is utilized for remote sensing monitoring of the Yangtze River basin. The UAV is equipped with remote sensing devices, such as cameras or multispectral sensors, to conduct aerial photography or remote sensing image acquisition of the target watershed. Leveraging mobility and flexibility of the UAV, high-resolution, multi-angle remote sensing image data are obtained. Hydrological monitoring stations, including water level stations, flow rate stations, or other hydrological observation equipment, are set up within the target watershed. These monitoring points are used for real-time monitoring of hydrological data, such as water levels, flow rates, and rainfall amounts. The real-time data acquired from these monitoring points are used for subsequent hydrological analysis and decision-making support. The global brightness calculation is performed on the loaded remote sensing images, which involves calculating the average value of the brightness values of all pixels in the images. This is achieved by summing the brightness values of each pixel and dividing by the total number of pixels. The brightness value of each pixel in the images is then adjusted to approach the overall average brightness value. Through this brightness equalization optimization, issues of excessive local brightness differences within the images are mitigated. For the river sections in the brightness-balanced remote sensing images, the texture feature enhancement processing is conducted. Image enhancement algorithms, such as filtering and sharpening, are applied to highlight and enhance the texture features of the rivers, making them clearer and more recognizable. Using the texture-enhanced remote sensing images, the topological analysis of water flow direction is performed through the image processing and analysis algorithms, such as edge detection and connectivity analysis. A goal of the topological analysis of water flow direction is to extract the topological structure of water flow, including main channels, tributaries, and confluence areas. Based on the results of the topological analysis of water flow direction, the extracted water flow topological structure is connected and organized to construct the water flow topological network. This network is represented in a form of a graph, where the relationships between channels and water flow are depicted as edges of the graph, and nodes represent the confluence or branching points of the channels.

In an embodiment, the step 15 includes steps as follows: Edge contour recognition of water flow paths is performed on the texture-enhanced remote sensing images to extract edge contour lines of water flow paths in the target watershed. A full-watershed water flow path analysis is performed on the target watershed based on the edge contour lines of water flow paths to obtain multiple water flow paths. A fine granularity of the grid cells is defined on the texture-enhanced remote sensing images. A regional gridding process is performed on the texture-enhanced remote sensing images based on the fine granularity of the grid cells to obtain a regional grid of the target watershed. A grid cell connectivity analysis is performed on the regional grid to obtain grid cell connectivity data. A logical analysis of the water flow direction is performed on the multiple water flow paths based on the grid cell connectivity data to generate direction logical data of the multiple water flow paths. A spatial topological distribution analysis is performed on the multiple water flow paths to obtain spatial topological distribution data of the multiple water flow paths. And a global path topological connectivity visualization is performed on the spatial topological distribution data of the multiple water flow paths based on the direction logical data of the multiple water flow paths to construct the water flow topological network.

In the embodiment, edge detection and contour extraction are performed on the texture-enhanced remote sensing images to identify the extract edge contour lines of rivers and extract the boundary information of water flow paths. Based on the extracted edge contour lines of water flow paths, a full-watershed water flow path analysis is performed across the entire watershed. Through the topological analysis and the connectivity analysis, multiple complete water flow paths are identified. The texture-enhanced remote sensing images are divided into the fine granularity of the grid cells, with a scale of the grid cells chosen appropriately according to the actual situation to achieve a suitable resolution. The regional gridding process is performed on the texture-enhanced remote sensing images, and the pixel attributes within each grid cell are homogenized to obtain regional grid data. The spatial connectivity between adjacent grid cells is analyzed to obtain complete grid cell connectivity data, which serves as the basis for subsequent flow direction analysis. Combining the grid cell connectivity data, a logical analysis of the water flow direction is performed on the previously identified multiple water flow paths to determine the direction of each grid cell connection and the flow direction of each grid cell on the water flow paths. The specific flow direction of each water flow path is established, forming the direction logical data of the multiple water flow paths. The spatial distribution topological relationships of multiple water flow paths are analyzed to obtain specific spatial topological distribution data of the water flow paths within the targeted watershed. The direction logical data of the multiple water flow paths and the spatial topological distribution data are integrated to construct the complete water flow topological network model, which visually presents the entire hydrological system of the targeted watershed.

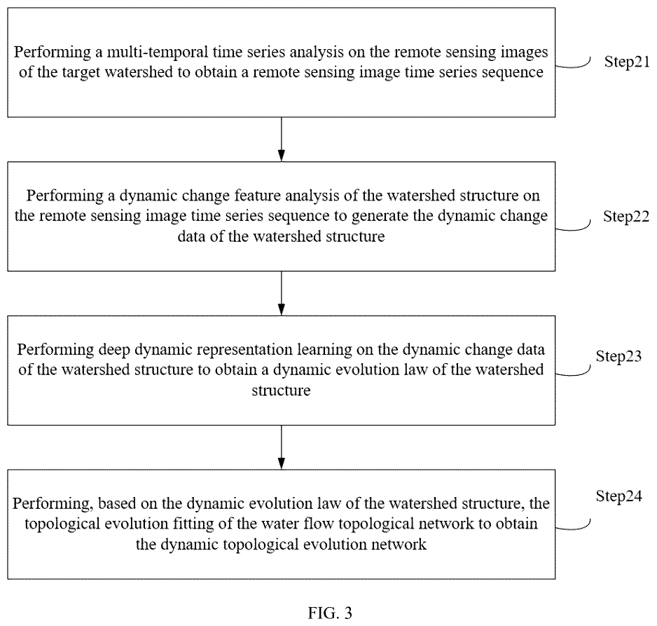

In an embodiment, as shown in FIG. 3, which illustrates a specific schematic flowchart of step 2 in the disclosure, step 2 specifically includes step 21-24 as follows.

In step 21: a multi-temporal time series analysis is performed on the remote sensing images of the target watershed to obtain a remote sensing image time series sequence. in step 22: a dynamic change feature analysis of the watershed structure is performed on the remote sensing image time series sequence to generate the dynamic change data of the watershed structure. In step 23: deep dynamic representation learning is performed on the dynamic change data of the watershed structure to obtain a dynamic evolution law of the watershed structure. And in step 24: the topological evolution fitting of the water flow topological network is performed based on the dynamic evolution law of the watershed structure to obtain the dynamic topological evolution network.

In the embodiment, remote sensing image data containing multiple time points of the target watershed are acquired. These time points are remote sensing images from adjacent time periods, aimed at capturing the dynamic changes within the targeted watershed. Preprocessing (i.e., multi-temporal time series analysis) is performed on the remote sensing images of each time point, including noise reduction, radiometric correction, and atmospheric correction. The preprocessed remote sensing images are then combined in chronological order to form a remote sensing image time series sequence. Each image at a time point is represented as a matrix or multi-band image, while the time series is composed of images from multiple time points. Comparative analysis is conducted on the dynamic changes of elements such as watershed topography, river channels, and vegetation in the remote sensing image time series sequence. Structural change characteristics of each element within the targeted watershed over the time series are identified, and a dataset describing the dynamic changes in watershed structure is generated. The deep learning time series analysis methods (i.e., deep dynamic representation learning) are employed to model the dynamic changes in watershed structure. Through deep learning training, potential regularities in the evolution of the watershed structure are extracted and characterized, resulting in models or parameters that can describe the mechanisms of watershed structural evolution. The water flow topological network is integrated with the dynamic evolution patterns of the watershed structure. Based on these dynamic evolution patterns, the topological structure of the water flow topological network is subjected to situation prediction and simulation. By applying the dynamic evolution patterns of the watershed structure to the topological structure of the water flow topological network, topological structure of the network changes over time. According to the fitted topological evolution, theories related to network science, such as graph theory and complex network analysis, are used to fit and predict the evolution trends of hydrological structure of the targeted watershed. The changes in river channels and hydrological structures within the targeted watershed are tracked and analyzed, and dynamic evolution processes such as river migration and hydrological restructuring occurring within the targeted watershed are identified. A dynamic topological evolution network is generated, which represents the changes in the nodes and the edges of the water flow topological network at different time points. Graph theory and network analysis methods are used to construct and analyze the dynamic topological evolution network.

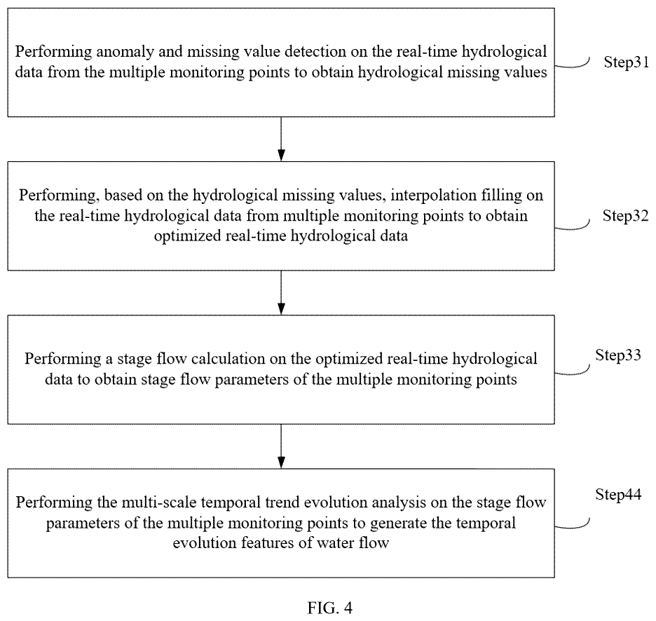

In an embodiment, as shown in FIG. 4, which illustrates a specific schematic flowchart of step 3 in the disclosure, and the step 3 specifically includes steps 31-34 as follows.

In step 31: anomaly and missing value detection is performed on the real-time hydrological data from the multiple monitoring points to obtain hydrological missing values. In step 32: interpolation filling is performed on the real-time hydrological data from multiple monitoring points based on the hydrological missing values to obtain optimized real-time hydrological data. In step 33: a stage flow calculation is performed on the optimized real-time hydrological data to obtain stage flow parameters of the multiple monitoring points. And in step 34: the multi-scale temporal trend evolution analysis is performed on the stage flow parameters of the multiple monitoring points to generate the temporal evolution features of water flow.

In the embodiment, anomaly and missing value detection are performed on real-time hydrological data using statistical methods, time series analysis, machine learning, and other techniques to identify anomalies and missing values in the data. Anomalies are abnormal data caused by equipment failure or unusual circumstances, while missing values result from data collection or transmission issues. Based on the characteristics of the real-time hydrological data and the distribution of missing values, appropriate interpolation methods are selected. Common interpolation methods include linear interpolation, spline interpolation, and kriging interpolation. The chosen interpolation method should accurately estimate missing values while maintaining data continuity. The selected interpolation method is applied to fill in the missing values in the real-time hydrological data. By using surrounding existing data points, missing values are estimated through interpolation calculations. The filled data replaces the missing values in the original data, resulting in optimized real-time hydrological data. A sequence of the optimized real-time hydrological data is segmented according to a specific time scale (such as daily, weekly, or monthly). For each time segment, flow rate parameters, such as average flow and peak flow, are calculated using flow rate formulas, forming a segmented flow rate parameter sequence that includes multiple monitoring points. Time series analysis methods are employed to conduct trend analysis, identifying the evolutionary characteristics of flow rates at different time scales for each monitoring point, such as seasonal variations and long-term trends. By comprehensively analyzing the temporal evolution features of flow rates from multiple points, the dynamic evolution patterns of the hydrological structure of the entire watershed are delineated.

In an embodiment, the step 34 specifically includes steps as follows.

Multi-temporal frequency decomposition is performed on the stage flow parameters of the multiple monitoring points to obtain a multi-scale power spectrum of the water flow. Periodic fluctuation feature extraction is performed on the multi-scale power spectrum of the water flow to obtain periodic fluctuation features. Non-stationary variable identification is performed on the periodic fluctuation features to obtain non-stationary variable values of the multi-scale power spectrum. Trend turning point marking is performed on the multi-scale power spectrum of the water flow based on the non-stationary variable values of the multi-scale power spectrum to obtain trend turning points. And the multi-scale temporal trend evolution analysis is performed on the trend turning points to generate the temporal evolution features of water flow.

The disclosure performs the multi-temporal frequency decomposition on the stage flow parameters from the multiple monitoring points, breaking down the water flow data into components of different scales to obtain the multi-scale power spectrum of water flow. The multi-scale power spectrum of water flow provides information on the energy distribution across different frequencies and time scales, revealing the periodic fluctuation characteristics of water flow. It performs the periodic fluctuation feature extraction on the multi-scale power spectrum of water flow to identify periodic components and fluctuation features within the multi-scale power spectrum. The extracted periodic fluctuation features include information such as peaks, troughs, and fluctuation amplitudes, which are used to describe the periodic changes and fluctuation conditions of water flow. It performs the non-stationary variable identification on the periodic fluctuation features to detect non-stationary variable values in the multi-scale power spectrum. These non-stationary variable values provide information on the non-stationarity of water flow fluctuations, aiding in the understanding and analysis of the characteristics of water flow changes. Based on the non-stationary variable values of the multi-scale power spectrum, it performs the trend turning point marking on the multi-scale power spectrum of water flow to identify the points where trends change. These trend turning points reveal the inflection points in the trends of water flow changes and mark significant fluctuation turning positions. It performs temporal trend evolution analysis on the trend turning points to analyze the trend changes and evolution patterns in the time series data of water flow. The generated temporal evolution features of water flow can include information such as trend increases, decreases, and periodic changes, providing a temporal feature description of water flow variations.

In an embodiment, the step 4 specifically includes steps 41-44 as follows.

In step 41: spatial correlation analysis is performed on the real-time hydrological data from the multiple monitoring points to generate spatial correlation data of the multiple monitoring points. In step 42: spatial registration is performed on the temporal evolution features of water flow based on the spatial correlation data of the multiple monitoring points to obtain spatial locations of the temporal evolution features. In step 43: the temporal evolution features of water flow are mapped to the dynamic topological evolution network based on the spatial locations of the temporal evolution features, and dynamic rendering modeling is performed to construct the three-dimensional hydrological evolution model. And in step 44: a hydrological dynamics simulation calculation of a future time period is performed on the three-dimensional hydrological evolution model to generate the hydrological dynamics simulation data of the target watershed.

In the embodiment, time-frequency analysis methods (such as wavelet transform, Hilbert-Huang transform, etc.) are employed to perform multi-time-scale spectral decomposition on these water flow data, breaking down the water flow parameters into components of different scales and frequencies. The resulting multi-scale power spectrum describes the periodic characteristics of water flow at different time scales. By analyzing the multi-scale power spectrum of water flow, significant periodic fluctuation features at each time scale are identified, and relevant features of these significant periodic fluctuations, such as dominant periods and power intensity, are extracted. The stability of periodic fluctuation features over time is assessed. For periodic fluctuation features with non-stationarity, the degree of non-stationarity is quantified to obtain the non-stationary variable values of the power spectrum. By analyzing the multi-scale power spectrum of water flow, key time points that represent trend turning points at different time scales are identified and marked, preparing for subsequent temporal evolution analysis. The time series of water flow parameters from multiple monitoring points are segmented and analyzed to characterize the trend changes in each segment. By comprehensively analyzing the trend evolution features of each monitoring point, the temporal dynamic evolution patterns of water flow at the watershed scale are summarized.

In an embodiment, the step 5 specifically includes steps 51-55 as follows.

In step 51: water level distribution analysis is performed on the hydrological dynamics simulation data of the target watershed at different time points to obtain water level distribution data at the different time points. In step 52: the water level trend prediction is performed on the water level distribution data at the different time points to generate the predicted water level trend values. In step 53: hyperparameter optimization is performed on the predicted water level trend values to obtain trend prediction hyperparameters. In step 54: iterative sliding time series prediction is performed based on the trend prediction hyperparameters to obtain a water level trend prediction sequence. in step 55: the smoothing fitting is performed on the water level trend prediction sequence to construct the water level trend prediction curve.

In the embodiment, spatial statistical analysis methods (such as kriging interpolation, covariance function fitting, etc.) are employed to perform spatial correlation analysis on the hydrological data from the different monitoring points. The resulting spatial correlation data of the monitoring points describe the spatial relationships between them, such as correlation coefficients and spatial distances. The temporal evolution features are then mapped and registered to their spatial locations, determining the exact positions of each temporal evolution feature within the watershed space. This process generates spatial location data for the evolution features. The spatial locations of the water flow temporal evolution features are mapped to the corresponding nodes in the dynamic topological evolution network. By matching the spatial location information of the evolution features with the node positions in the dynamic topological evolution network, the evolution features are correlated with the network. Utilizing the correspondence between the dynamic topological evolution network and the evolution features, dynamic rendering and modeling are performed. The nodes in the network are dynamically adjusted according to changes in the evolution features to simulate the spatiotemporal evolution process of the hydrological system, constructing a three-dimensional hydrological evolution model. Parameters are set for the constructed three-dimensional hydrological evolution model, including watershed characteristics, topographic data, initial conditions, etc. Based on the set model parameters, the hydrological dynamics simulation calculation of the future time period is conducted. Appropriate hydrological models are used, considering factors such as precipitation, evaporation, and groundwater flow, to simulate the hydrological processes within the watershed for future time periods and generate corresponding hydrological dynamics simulation data.

In an embodiment, the step 6 specifically includes steps 61-65 as follows.

In step 61: water level change rate calculation is performed on the water level trend prediction curve to obtain a water level trend change rate. In step 62: quantitative analysis of water level peaks is performed based on the water level trend change rate to obtain water level peak trend data. In step 63: the dynamic water level risk analysis is performed on the water level peak trend data based on the preset water level risk assessment criteria to obtain water level risk assessment data. In step 64: risk decision analysis is performed on the water level risk assessment data to generate the water level risk decision-making strategy. And in step 65: the real-time dynamic water level early warning operations are executed based on the water level risk decision-making strategy.

In the embodiment, differential calculations are performed on the water level trend prediction curve to obtain the water level change rates at each moment, namely the water level trend change rate. The water level change rate is calculated by dividing the difference in water levels between adjacent time points by a time interval. Utilizing the data of water level trend change rate, occurrence of water level peaks is detected. The positions of water level peaks are determined by identifying local maxima on the change rate curve. The time points and corresponding water levels of the peaks are extracted to form water level peak trend data. These data are used to analyze the trends and characteristics of water level peaks. Based on specific circumstances and requirements, preset water level risk assessment criteria are established. These criteria include different water level categories, corresponding risk levels, and thresholds. According to the water level peak trend data and the preset water level risk assessment criteria, each water level peak is assessed for risk. The risk level of the water level is determined based on the magnitude of the peak and its comparison with the assessment criteria. The risk levels of the water level peaks and their corresponding time points are organized into water level risk assessment data for subsequent risk decision analysis. Based on the water level risk assessment data and actual needs, indicators for risk decision-making are determined, such as risk levels and early warning thresholds. Based on these risk decision-making indicators, the water level risk assessment data are analyzed to formulate response strategies and decision actions for different risk levels, such as early warning measures and emergency response plans for different risk levels. According to results of the risk decision analysis, water level risk decision strategies are generated, including warning levels, triggering conditions, and response measures. A system for the real-time river water level monitoring and early warning based on deep learning is configured to execute the method mentioned above, which includes a flow topology module, a situation evolution module, a temporal trend evolution module, a hydrological evolution model module, a water level trend prediction module, and a water level risk early warning module. The flow topology module is configured to acquire remote sensing images of a target watershed and real-time hydrological data from multiple monitoring points, and perform a topological analysis of water flow direction on the remote sensing images of the target watershed to construct a water flow topological network. The situation evolution module is configured to perform a dynamic change feature analysis of a watershed structure on the remote sensing images of the target watershed to generate dynamic change data of the watershed structure, and perform, based on the dynamic change data of the watershed structure, a topological evolution fitting on the water flow topological network to obtain a dynamic topological evolution network. The temporal trend evolution module is configured to perform a multi-scale temporal trend evolution analysis on the real-time hydrological data from the multiple monitoring points to generate temporal evolution features of water flow. The hydrological evolution model module is configured to perform, based on the temporal evolution features of water flow, an evolution feature spatial location mapping on the dynamic topological evolution network to construct a three-dimensional hydrological evolution model, and generate hydrological dynamics simulation data of the target watershed based on the three-dimensional hydrological evolution model. The water level trend prediction module is configured to perform a water level trend prediction on the hydrological dynamics simulation data of the target watershed to generate predicted water level trend values, and perform a smoothing fitting on the predicted water level trend values to construct a water level trend prediction curve. And the water level risk early warning module is configured to perform, based on preset water level risk assessment criteria, a dynamic water level risk analysis on the water level trend prediction curve to generate a water level risk decision-making strategy configured to perform real-time dynamic water level early warning operations.

The system of the disclosure acquires the remote sensing images of the target watershed and the real-time hydrological data from the multiple monitoring points, providing spatial information of the target watershed and hydrological data. The system performs the topological analysis of water flow direction to reveal the pathways and directional relationships of water flow within the targeted watershed. The constructed water flow topological network forms the topological structure of water flow within the targeted watershed, providing a basis for subsequent hydrological analysis. The system performs the dynamic change feature analysis of the watershed structure on the remote sensing images of the target watershed to understand the changes in the topography, the land use, and other factors within the targeted watershed. The generated dynamic change data of the watershed structure provides information on the evolution of the watershed structure, allowing for the analysis of trends and characteristics within the targeted watershed. The system performs the topological evolution fitting of the water flow topological network, integrating the changes in watershed structure with the topological relationships of water flow. The resulting dynamic topological evolution network provides a simulation result of how the water flow topology changes over time, facilitating an understanding of the dynamic changes in water flow paths within the targeted watershed. The system performs the multi-scale temporal trend evolution analysis on the real-time hydrological data from the multiple monitoring points to reveal the patterns of change in water flow rates. The generated temporal evolution features of water flow provide information on the temporal evolution of hydrological data, enabling an understanding of the trends and periodic changes in water flow rates. Based on the temporal evolution features of water flow, the system maps the evolution features to the dynamic topological evolution network, integrating the hydrological data with the topological network. The constructed three-dimensional hydrological evolution model provides a simulation result of the hydrological processes within the targeted watershed, allowing for a comprehensive analysis of the changes and interactions of hydrological elements. The system performs the water level trend prediction on the hydrological dynamics simulation data of the targeted watershed to gain advance knowledge of the trends and peaks in water level changes. The generated predicted water level trend values provide forecast results for water levels over a future period, enabling the formulation of corresponding early warning strategies and response measures. The system performs the smoothing fitting on the predicted water level trend values to eliminate noise and abrupt changes, resulting in a smoother water level prediction curve. Based on the preset water level risk assessment criteria, the system performs the dynamic water level risk analysis on the water level trend prediction curve to assess the risk level of water levels. The generated water level risk decision-making strategies provide recommendations for different water level risk levels, enabling the formulation of water level early warning and emergency response strategies. By executing the real-time dynamic water level early warning operations, which enables the timely issuance of water level early warning signals, provides decision support and early warning prompts, and helps to reduce the risk of floods.

Therefore, from any point of view, the embodiments should be regarded as exemplary and non-limited, and the scope of the disclosure is limited by the appending claims rather than the above description. Therefore, it is intended to encompass all variations falling within the meaning and scope of the equivalent elements of the disclosure within the scope of the disclosure.

The above description is only a specific embodiment of the disclosure, which enables those skilled in the art to understand or implement the disclosure. Various modifications to these embodiments will be apparent to those skilled in the art, and the general principles defined herein can be implemented in other embodiments without departing from the spirit or scope of the disclosure. Therefore, the disclosure will not be limited to the embodiments shown herein, but will be within the widest scope consistent with the principles and novel features disclosed herein.

What is claimed is:

1. A method for real-time river water level monitoring and early warning based on deep learning, the method comprising the following steps:
step 1: acquiring remote sensing images of a target watershed and real-time hydrological data from multiple monitoring points; and performing a topological analysis of water flow direction on the remote sensing images of the target watershed to construct a water flow topological network;
step 2: performing a dynamic change feature analysis of a watershed structure on the remote sensing images of the target watershed to generate dynamic change data of the watershed structure; and performing, based on the dynamic change data of the watershed structure, a topological evolution fitting on the water flow topological network to obtain a dynamic topological evolution network, wherein the step 2 comprises:
step 21: performing a multi-temporal time series analysis on the remote sensing images of the target watershed to obtain a remote sensing image time series sequence;
step 22: performing the dynamic change feature analysis of the watershed structure on the remote sensing image time series sequence to generate the dynamic change data of the watershed structure;
step 23: performing deep dynamic representation learning on the dynamic change data of the watershed structure to obtain a dynamic evolution law of the watershed structure; and
step 24: performing, based on the dynamic evolution law of the watershed structure, the topological evolution fitting of the water flow topological network to obtain the dynamic topological evolution network;
step 3: performing a multi-scale temporal trend evolution analysis on the real-time hydrological data from the multiple monitoring points to generate temporal evolution features of water flow;
step 4: performing, based on the temporal evolution features of water flow, an evolution feature spatial location mapping on the dynamic topological evolution network to construct a three-dimensional hydrological evolution model; and generating hydrological dynamics simulation data of the target watershed based on the three-dimensional hydrological evolution model;
step 5: performing a water level trend prediction on the hydrological dynamics simulation data of the target watershed to generate predicted water level trend values; and performing a smoothing fitting on the predicted water level trend values to construct a water level trend prediction curve; and
step 6: performing, based on preset water level risk assessment criteria, a dynamic water level risk analysis on the water level trend prediction curve to generate a water level risk decision-making strategy and perform real-time dynamic water level early warning operations.

2. The method for real-time river water level monitoring and early warning based on deep learning as claimed in claim 1, wherein the step 1 comprises:
step 11: acquiring, using an unmanned aerial vehicle (UAV), the remote sensing images of the target watershed; and acquiring, based on hydrological monitoring stations, the real-time hydrological data from the multiple monitoring points;
step 12: performing a global brightness average calculation on the remote sensing images of the target watershed to obtain an average brightness value of the remote sensing images;
step 13: performing brightness equalization optimization on the remote sensing images of the target watershed based on the average brightness value, to obtain brightness-balanced remote sensing images;
step 14: performing river texture feature enhancement processing on the brightness-balanced remote sensing images to obtain texture-enhanced remote sensing images; and
step 15: performing the topological analysis of water flow direction on the texture-enhanced remote sensing images to construct the water flow topological network.

3. The method for real-time river water level monitoring and early warning based on deep learning as claimed in claim 2, wherein the step 15 comprises:
performing edge contour recognition of water flow paths on the texture-enhanced remote sensing images to extract edge contour lines of water flow paths in the target watershed;
performing a full-watershed water flow path analysis on the edge contour lines of water flow paths to obtain multiple water flow paths;
defining a fine granularity of grid cells based on the texture-enhanced remote sensing images;
performing, based on the fine granularity of the grid cells, a regional gridding process on the texture-enhanced remote sensing images to obtain a regional grid of the target watershed;
performing a grid cell connectivity analysis on the regional grid to obtain grid cell connectivity data;
performing, based on the grid cell connectivity data, a logical analysis of the water flow direction on the multiple water flow paths to generate direction logical data of the multiple water flow paths;
performing a spatial topological distribution analysis on the multiple water flow paths to obtain spatial topological distribution data of the multiple water flow paths; and
performing, based on the direction logical data of the multiple water flow paths, a global path topological connectivity visualization on the spatial topological distribution data of the multiple water flow paths to construct the water flow topological network.

4. The method for real-time river water level monitoring and early warning based on deep learning as claimed in claim 1, wherein the step 3 comprises:
step 31: performing anomaly and missing value detection on the real-time hydrological data from the multiple monitoring points to obtain hydrological missing values;
step 32: performing, based on the hydrological missing values, interpolation filling on the real-time hydrological data from the multiple monitoring points to obtain optimized real-time hydrological data;
step 33: performing a stage flow calculation on the optimized real-time hydrological data to obtain stage flow parameters of the multiple monitoring points; and
step 34: performing the multi-scale temporal trend evolution analysis on the stage flow parameters of the multiple monitoring points to generate the temporal evolution features of water flow.

5. The method for real-time river water level monitoring and early warning based on deep learning as claimed in claim 4, wherein the step 34 comprises:
performing multi-temporal frequency decomposition on the stage flow parameters of the multiple monitoring points to obtain a multi-scale power spectrum of water flow;
performing periodic fluctuation feature extraction on the multi-scale power spectrum of water flow to obtain periodic fluctuation features;
performing non-stationary variable identification on the periodic fluctuation features to obtain non-stationary variable values of the multi-scale power spectrum;
performing, based on the non-stationary variable values of the multi-scale power spectrum, trend turning point marking on the multi-scale power spectrum of water flow to obtain trend turning points; and
performing the multi-scale temporal trend evolution analysis on the trend turning points to generate the temporal evolution features of water flow.

6. The method for real-time river water level monitoring and early warning based on deep learning as claimed in claim 1, wherein the step 4 comprises:
step 41: performing spatial correlation analysis on the real-time hydrological data from the multiple monitoring points to generate spatial correlation data of the multiple monitoring points;
step 42: performing, based on the spatial correlation data of the multiple monitoring points, spatial registration on the temporal evolution features of water flow to obtain spatial locations of the temporal evolution features;
step 43: mapping, based on the spatial locations of the temporal evolution features, the temporal evolution features of water flow to the dynamic topological evolution network, and performing dynamic rendering modeling to construct the three-dimensional hydrological evolution model; and
step 44: performing a hydrological dynamics simulation calculation of a future time period on the three-dimensional hydrological evolution model to generate the hydrological dynamics simulation data of the target watershed.

7. The method for real-time river water level monitoring and early warning based on deep learning as claimed in claim 1, wherein the step 5 comprises:
step 51: performing water level distribution analysis on the hydrological dynamics simulation data of the target watershed at different time points to obtain water level distribution data at the different time points;
step 52: performing the water level trend prediction on the water level distribution data at the different time points to generate the predicted water level trend values;
step 53: performing hyperparameter optimization on the predicted water level trend values to obtain trend prediction hyperparameters;
step 54: performing, based on the trend prediction hyperparameters, iterative sliding time series prediction to obtain a water level trend prediction sequence; and
step 55: performing the smoothing fitting on the water level trend prediction sequence to construct the water level trend prediction curve.

8. The method for real-time river water level monitoring and early warning based on deep learning as claimed in claim 1, wherein the step 6 comprises:
step 61: performing water level change rate calculation on the water level trend prediction curve to obtain a water level trend change rate;
step 62: performing, based on the water level trend change rate, quantitative analysis of water level peaks to obtain water level peak trend data;
step 63: performing, based on the preset water level risk assessment criteria, the dynamic water level risk analysis on the water level peak trend data to obtain water level risk assessment data;
step 64: performing risk decision analysis on the water level risk assessment data to generate the water level risk decision-making strategy; and
step 65: executing the real-time dynamic water level early warning operations based on the water level risk decision-making strategy.

9. A system for real-time river water level monitoring and early warning based on deep learning, configured to execute the method for real-time river water level monitoring and early warning based on deep learning as claimed in claim 1, and the system comprising:
a flow topology module, configured to acquire the remote sensing images of the target watershed and the real-time hydrological data from the multiple monitoring points, and perform the topological analysis of the water flow direction on the remote sensing images of the target watershed to construct the water flow topological network;
a situation evolution module, configured to perform the dynamic change feature analysis of the watershed structure on the remote sensing images of the target watershed to generate the dynamic change data of the watershed structure, and perform, based on the dynamic change data of the watershed structure, the topological evolution fitting on the water flow topological network to obtain the dynamic topological evolution network;
a temporal trend evolution module, configured to perform the multi-scale temporal trend evolution analysis on the real-time hydrological data from the multiple monitoring points to generate the temporal evolution features of water flow;
a hydrological evolution model module, configured to perform, based on the temporal evolution features of water flow, the evolution feature spatial location mapping of the dynamic topological evolution network to construct the three-dimensional hydrological evolution model, and generate the hydrological dynamics simulation data of the target watershed based on the three-dimensional hydrological evolution model;
a water level trend prediction module, configured to perform the water level trend prediction on the hydrological dynamics simulation data of the target watershed to generate the predicted water level trend values, and perform the smoothing fitting on the predicted water level trend values to construct the water level trend prediction curve; and
a water level risk early warning module, configured to perform, based on preset water level risk assessment criteria, the dynamic water level risk analysis on the water level trend prediction curve to generate the water level risk decision-making strategy configured to perform the real-time dynamic water level early warning operations.
